(19) United States
(12) Patent Application Publication
(10) Pub. No.: US 2022/0245567 A1
(43) Pub. Date: Aug. 4, 2022

(54) ASSET TRACKING MANAGEMENT SYSTEM FOR CATEGORIZING A DORMANT STATUS OF AN ASSET

(71) Applicant: MOTOROLA SOLUTIONS, INC., CHICAGO, IL (US)

(72) Inventors: MELANIE KING, HOLLYWOOD, FL (US); MATTHEW E. SIMMS, DAVIE, FL (US); CHIRAYU M. PATEL, SUNRISE, FL (US)

(21) Appl. No.: 17/165,397

(22) Filed: Feb. 2, 2021

(51) Int. Cl. G06Q 10/08; G06N 20/00

(52) U.S. Cl. CPC G06Q 10/087; G06N 20/00

(57) ABSTRACT

A method and system for categorizing portable radio assets managed by a server. The method includes evaluating status data, from a memory, for a portable radio asset, the status data including when a communication from the portable radio asset was last received by the server, determining that the portable radio asset is dormant when a time period following receipt of the communication exceeds a predetermined time threshold, and retrieving information corresponding to a situational circumstance of the portable radio asset. The method further includes performing analytics on the information, categorizing, based on the analytics, the portable radio asset into a subcategory, the subcategory characterizing a dormant status of the portable radio asset, updating a database to include the dormant portable radio asset categorized in the dormant status subcategory. The updated database, including the dormant portable radio asset categorized in the dormant status subcategory, is accessible to an external device for display on a graphical user interface of the external device.

### BACKGROUND OF THE INVENTION

Enterprises may provide employees, clients, and/or customers electronic inventory/equipment (assets) for temporary use. For example, public safety agencies may assign or distribute assets, such as radios, batteries, accessories, and the like, to individual users. Loss prevention of such assets is particularly important, particularly in the public safety arena, where such assets may be utilized by law enforcement, fire rescue, and paramedics, to name a few. However, the ability to track and manage assets can be challenging. As the number of assets increases, the ability to track and manage the assets becomes increasingly complex.

Accordingly, there is a need for an improved approach to asset tracking management.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a communication system in accordance with some embodiments.

FIG. 2A is a diagram of a server of the system of FIG. 1 in accordance with some embodiments.

FIG. 2B is a diagram of a management workstation of the system of FIG. 1 in accordance with some embodiments.

FIG. 3 is a flowchart of a method of categorizing a portable radio asset performed via the system of FIG. 1, in accordance with some embodiments.

FIG. 4 is a chart illustrating information used in the categorization of the portable radio asset in the method of FIG. 3 in accordance to some embodiments.

FIG. 5A is a screen generated by graphical user interface software of the management workstation of FIG. 2B in accordance to some embodiments.

FIG. 5B is a screen generated by graphical user interface software of the management workstation of FIG. 2B in accordance to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Briefly, there is provided herein an asset management tracking system that be used by enterprises to track the physical location of and manage a plurality of electronic devices. For example, public safety agencies may utilize the tracking and management system provided herein to track personal communications devices (often referred to as “radios”), batteries, accessories and the like. The embodiments provide for a system which aids in the prevention of asset loss, by ensuring that an accurate use status of an asset is recorded. For the purposes of this application, a portable radio asset may refer to a battery for a portable radio device, the battery-powered device itself of an electronic accessory of the portable radio device. In a determination of a use status of an asset, the time that an asset last connected to the asset tracking management network (when the asset was last “seen”) may be evaluated. When the asset has not been “seen” for a certain amount of time, the asset's use status may be determined to be dormant. Further refinement of the dormant status of the asset is provided to distinguish subcategories associated with the dormant asset which facilitates determination of whether the dormant asset is lost or broken or is somewhere still within the enterprise or assigned to an individual within the enterprise.

Accordingly, systems and methods described herein are directed to, among other things, detection and classification of a dormant status of a portable radio asset. One embodiment provides a server for categorizing portable radio assets in a cloud-based communication system. The server includes an electronic processor communicatively coupled to a memory. The server is preferably a remote server communicating with a portable radio over a wireless connection of the cloud-based communication system. The electronic processor is configured to evaluate status data, from the memory, for a portable radio asset of the portable radio, the status data including when a communication associated with the portable radio asset was last received by the server, determine that the portable radio asset is dormant when a time period following receipt of the communication exceeds a predetermined threshold, and retrieve information corresponding to a situational circumstance of the portable radio asset. The electronic processor is further configured to perform analytics on the information, categorize, based on the analytics, the portable radio asset into a subcategory, the subcategory characterizing a dormant status of the portable radio asset, and update a database to include the dormant portable radio asset categorized in the dormant status subcategory. The updated database, including the dormant portable radio asset categorized in the dormant status subcategory, is accessible to an external device communicating with the server through the cloud-based communication system for display on a graphical user interface of the external device.

Another embodiment provides a method of categorizing portable radio assets managed by a server communicating with the portable radio over a wireless connection of the cloud-based communication system. The method includes evaluating status data, from a memory, for a portable radio asset of the portable radio, the status data including when a communication associated with the portable radio asset was last received by the server, determining that the portable radio asset is dormant when a time period following receipt of the communication exceeds a predetermined threshold, and retrieving information corresponding to a situational circumstance of the portable radio asset. The method further includes performing analytics on the information, categorizing, based on the analytics, the portable radio asset into a subcategory, the subcategory characterizing a dormant status of the portable radio asset, updating a database to include the dormant portable radio asset categorized in the dormant status subcategory. The updated database, including the dormant portable radio asset categorized in the dormant status subcategory, is accessible to an external device communicating with the server through the cloud-based communication system for display on a graphical user interface of the external device.

The embodiments further provide for a communication system, comprising a plurality of portable radio assets and a server for communicating with the plurality of portable radio assets. The server determines when a portable radio asset of the plurality of portable radio assets has gone dormant based on a predetermined time threshold without communication. The system may retrieve information corresponding to a situational circumstance associated with the dormant portable radio asset. The server performs analytics on the dormant portable radio asset to categorize the dormant portable radio asset into a dormant status subcategory. The system further comprises a database for storing analytical results pertaining to the dormant portable radio asset including the dormant status subcategory, and the analytical results pertaining to the dormant portable radio asset including the dormant status subcategory being accessible, to an external device, for asset tracking management for the plurality of portable radio assets.

Before embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

For ease of description, some of the example systems presented herein are illustrated with a single exemplar of each of its component parts. Some examples may not describe or illustrate all components of the systems. Other example embodiments may include more or fewer of each of the illustrated components, may combine some components, or may include additional or alternative components.

It should be understood that although the system depicts components as logically separate, such depiction is merely for illustrative purposes. In some embodiments, the illustrated components may be combined or divided into separate software, firmware, and/or hardware. Regardless of how they are combined or divided, these components may be executed on the same computing device or may be distributed among different computing devices (or electronic processors) connected by one or more networks or other suitable communication means.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

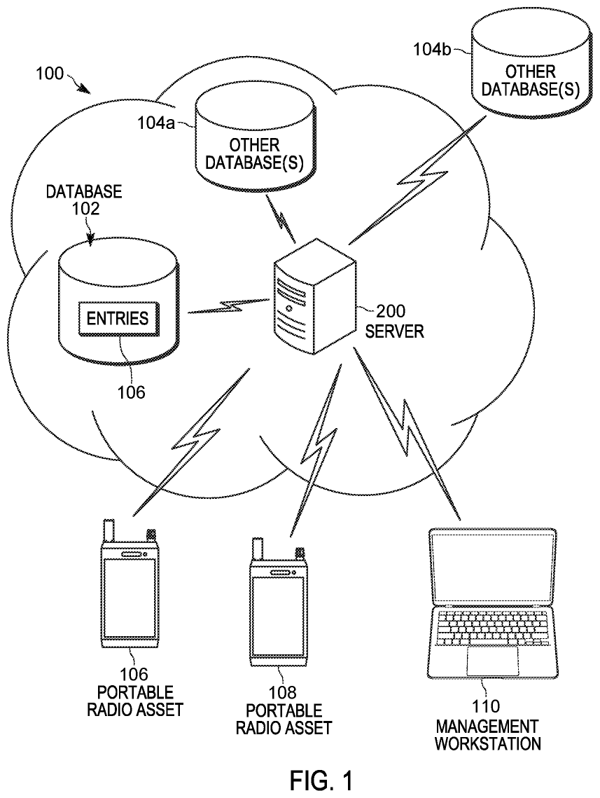

FIG. 1 is a diagram of one embodiment of a communication system 100. In the example shown, the communication system 100 includes a server 200 communicatively coupled to a database 102. The system 100 is configured to communicate with at least one of a plurality of portable radio assets 106 and 108. In some embodiments, the server communicates with the portable radio asset 106 and 108 over a wireless connection of the system 100, such as a wireless internet connection or other wireless connection suitable for communications between remote devices. As described in more detail below, for each portable radio asset (in the illustrated embodiment of FIG. 1, portable radio assets 106 and 108), a respective entry regarding at least a status of the portable radio asset is included within the database 102 (entries 103). Each of the entries 103 for each portable radio asset are managed by the server 200 as part of an asset tracking management system for an enterprise (for example, an public safety agency, rental company, and or other enterprise in which assets are distributed, loaned, or assigned). In some embodiments, the server 200 may be communicatively coupled to one or more additional servers, databases, and/or communication networks (for example, one or more other databases 104a, 104b which may operate within or external to the cloud based communication system, referred to generally as other databases 104). The server 200 is also communicatively coupled to a management workstation 110.

Portable radio assets 106 and 108 are illustrated as portable electronic communication devices (for example, portable radios) that include battery or battery pack. However, other devices may be considered portable radio assets. For example, batteries (including memory-enabled batteries) or other kinds of battery-powered devices (for example, tablet computers and laptop computers) are considered as portable radio assets for purposes of the examples explained and illustrated. In such embodiments, communications between the portable radio asset and one or more of the components of the system 100 may be performed via a transceiver of an electronic device connected to the memory-enabled battery. In some embodiments, each portable radio asset 106 and 108 is configured to retrieve and/or store information about itself including a unique identifier, a performance history, a current location status, and the like. In some embodiments, portable radio assets include only a memory and a battery and the information. In other examples, the portable radio assets 106 and 108 are equipped with a global positioning system (GPS) chip and/or a radio frequency identification (RFID) tag to enable determination of its location.

The communication system 100 (in particular, the server 200) is configured to record and manage a plurality of entries 103. Each entry corresponds to a particular portable radio asset (for example, portable radio assets 106 and 108) and is stored in the database 102. An entry of a portable radio asset may include various information regarding the portable radio asset and a user assigned to the portable radio asset as explained below. The database 102 may be a database housed on a suitable database server communicatively coupled to and accessible by the server 200. In alternative embodiments, the database 102 may be part of a cloud-based database system (for example, a data warehouse) external to the system 100 and accessible by the server 200 over one or more wired or wireless networks. In some embodiments, all or part of the database 102 may be locally stored on the server 200.

At a hardware level, components of the system 100 may be connected to one another via a wired network, a wireless network, or both. All or parts of the networks used in the system 100 may be implemented using various communication networks, for example, a cellular network, the Internet, a Bluetooth™ network, a wireless local area network (for example, Wi-Fi), a wireless accessory Personal Area Networks (PAN), a machine-to-machine (M2M) autonomous network, and the like. For example, in some embodiments the communication system 100 is a cloud-based system. The server 200, database 102, the portable radio assets 106 and 108, the management workstation 110, and other database(s) 104 and components of the system 100 communicate with each other using suitable wireless or wired communication protocols. The system 100 includes one or more servers or computers (for example, the server 200) including one or more processors configured to perform various functions, which are described below.

The server 200 is configured to receive information regarding a portable radio asset directly from a user (for example, via a graphical user interface of the management workstation 110 described below) regarding a particular portable radio asset, from the portable radio asset itself, and/or one or more additional databases 104 and store that information in a corresponding entry for the portable radio asset in the database 102. It should be noted that, for ease of description, the phrase “categorizing a portable radio asset” herein refers to updating a category/subcategory status of an entry corresponding to the portable radio asset stored in the database 102.

The one or more databases 104 may include certain information, for example, supplier data of an asset supplier that manufactured and/or provided the portable radio asset, an enterprise or personal calendar of a user assigned to the portable radio asset, a maintenance record database, and other information. The information may include information regarding the portable radio asset itself. For example, the information may include when the portable radio asset last communicated with the server 200, a record of the portable radio asset from the asset supplier database, and a last known location of the portable radio asset. The information may also include an aging characteristic of the portable radio asset and/or a performance characteristic of the portable radio asset. The information may also include information regarding a user currently assigned to the portable radio asset (for example, an identity of the user, a current employee status of the user, and the like). Information may also be determined by the server 200 itself via analytics on the collected information. In some embodiments, the information relates to a battery of the portable radio asset (for example, battery age and battery charge level). A dormant battery asset can be categorized based on the health status analytics.

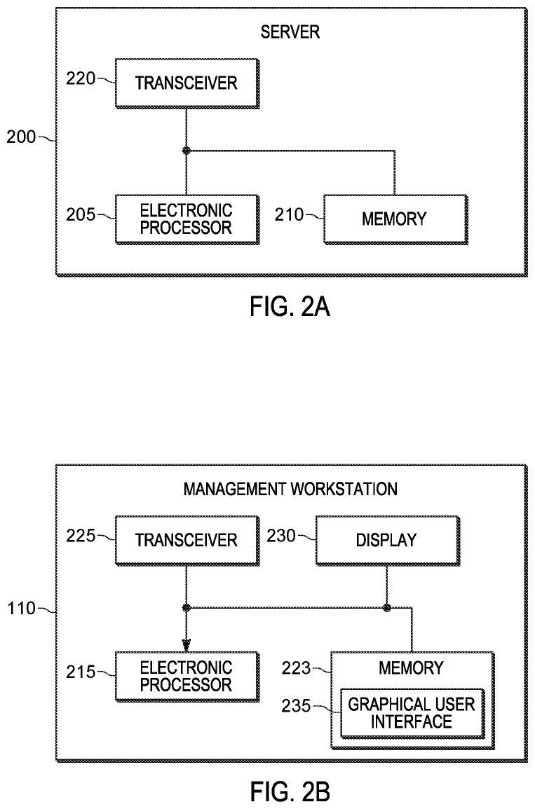

The management workstation 110 may be a computing device or computer system. A detailed block diagram illustrating the components of the management workstation is provided in FIG. 2B. As mentioned above, the management workstation 110 is configured to generate a graphical user interface (graphical user interface of FIG. 2B). The graphical user interface in conjunction with other input and output devices connected to the management workstation 110 may be used by a user to access (via the server 200) information (for example, an entry for a portable radio asset) in the database 102 and to provide information to and modify in the database 102. The workstation 110, communicating with the server 200 of the cloud-based communication system, can access database 102 to retrieve and display the dormant portable radio asset categorized into the dormant status subcategory for as part of the workstation's graphical user interface.

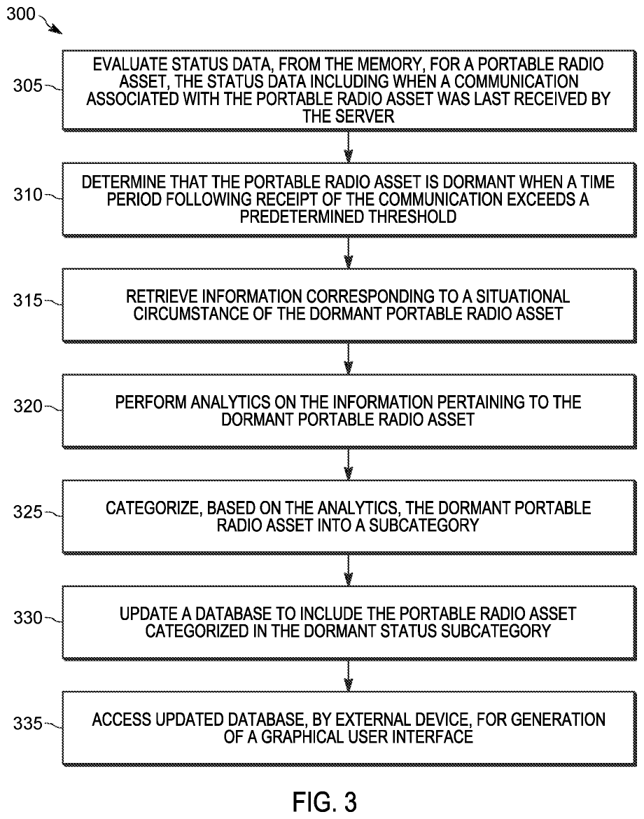

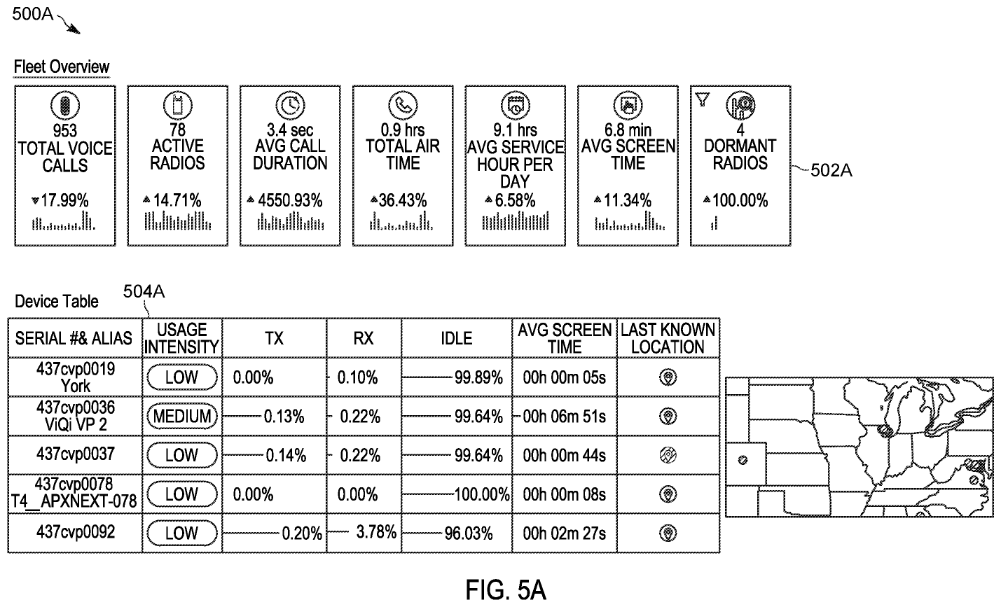

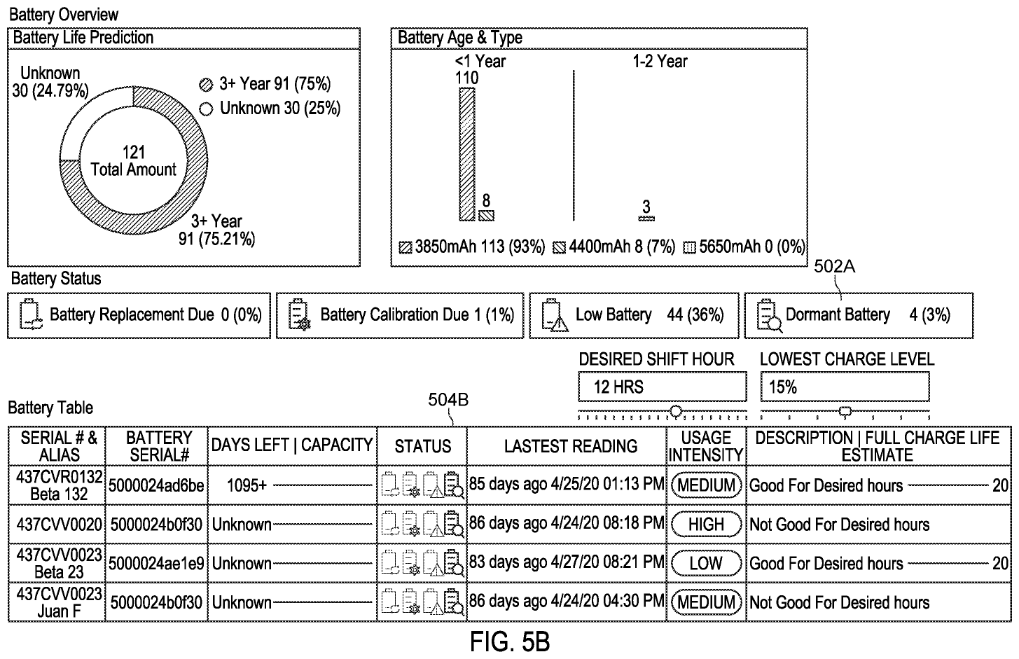

As explained below in more detail, the server 200 categorizes the dormant portable radio assets into sub-categories. The dormant portable radio asset and associated subcategories can be accessed by a remote device for use on a graphical user interface. For example, 502A of FIG. 5B shows the dormant asset while 504B shows a table (corresponding to use status category). As described in FIG. 3 below, the server 200 is configured to identify dormant portable radio assets and to categorize the dormant portable radio assets into subcategories of a dormant status. A dormant status is a status indicating that a portable radio asset has not communicated with the server 200/system 100 for more than a predetermined amount of time (for example, two weeks) and the subcategories provide more detailed information as to the dormant status.

For ease of description, the system 100 is described in terms of a hardware system. However, in some embodiments, some or all of the system 100 may be implemented in software as a virtual network system (for example, a cloud-based system). In other words, the system 100 can be defined as the combination of software and hardware included in one or more electrical computing devices that run software implementing processes of the system described herein.

FIG. 2A is a diagram of the server 200. In the embodiment illustrated, the server 200 includes an electronic processor 205 (for example, a microprocessor or the like), a memory 210, and a transceiver 220. The electronic processor 205, the memory 210, the transceiver 220, as well as other various modules (not shown) are communicatively coupled to each other via one or more wired/wireless connections. In alternate embodiments, the server 200 may include fewer or additional components in configurations different from that illustrated in FIG. 2A.

The memory 210 includes read only memory (ROM), random access memory (RAM), other non-transitory computer-readable media, or a combination thereof. The electronic processor 205 is configured to retrieve instructions and data from the memory 210 and execute, among other things, instructions to perform the methods described herein.

The electronic processor 205 is configured to control the transceiver 220 to transmit and receive electronic communication signals to and from one or more electronic devices (for example, portable radio assets 106 and 108). In some embodiments, the transceiver 220 is used for communications between one or more components of the system 100. The electronic processor 205 and the transceiver 220 may include various digital and analog components (for example, digital signal processors, and the like), which for brevity are not described herein and which may be implemented in hardware, software, or a combination of both. In some embodiments, the transceiver 220 includes a combined transmitter-receiver component. In other embodiments, the transceiver 220 includes separate transmitter and receiver components.

FIG. 2B is a diagram of the management workstation 110. In the embodiment illustrated, the workstation 110 includes an electronic processor 215 (for example, a microprocessor or the like), a memory 223, and a transceiver 225. The workstation also includes a display 230. The components of the management workstation 110 are communicatively coupled to each other via one or more wired/wireless connections. The processor 215, the memory 223, and the transceiver 225 are components similar to those described above in regard to FIG. 2A and so, for sake of brevity, only additional characteristics are described. The memory 223 stores instructions that, once executed by the processor 215, generate a graphical user interface 235 on the display 230. As mentioned above, a user of the management workstation 110 may use the interface 235 to review, provide, and modify the data regarding the portable radio assets stored within the database 102.

The display 230 displays images, video, text, and/or data from sensor inputs to the user (for example, an incident-handling dispatcher). The display 230 may be a liquid crystal display (LCD) screen or an organic light emitting display (OLED) display screen. In some embodiments, a touch sensitive input interface (utilized in the implementation of the graphical user interface 235) may be incorporated into the display 230 as well, allowing the user to interact with content provided on the display 230.

In some embodiments, the management workstation 110 may include fewer or additional components in configurations different from that illustrated in FIG. 2B. For example, the workstation 110 may include one or more additional input devices as well as output devices (not shown) such as a computer mouse and/or a keyboard that receives inputs from a user of the workstation 110 for use with the graphical user interface 235. In some embodiments, the components of the workstation 110 are dispersed over several electronic devices. In other embodiments, some or all of the workstation 110 may be implemented virtually (for example, the memory 223 may be implemented as a cloud-based storage). In some embodiments, one or more of the components of the management workstation 110 may be implemented on the server 200 and/or database 102.

In some embodiments, one or more of the components of the system 100 is/are implemented on multiple electronic devices that include components or combinations of different components, including all or some of the various components described above with respect to the server 200 and the management workstation 110. For example, the portable radio assets 106 and 108 may include an electronic processor, memory, and/or a transceiver. As a consequence, these components are not described in detail or explicitly illustrated.

In summary, the embodiments of FIGS. 1, 2A and 2B provide for a communication system, such as communication system 100, that can advantageously track and manage the plurality of portable radio assets 106, 108 (e.g. portable radio itself, battery, and/or accessory associated the portable radio). The server 200 communicating with the plurality of portable radio assets 106, 108 determines when a portable radio asset of the plurality of portable radio assets has gone dormant based on a predetermined time threshold without communication. The server 200 then performs analytics on the dormant portable radio asset to categorize the dormant portable radio asset into a dormant status subcategory. The database stores the analytical results pertaining to the dormant portable radio asset including the dormant status subcategory. The analytical results pertaining to the dormant portable radio asset (including the dormant status subcategory) area advantageously accessible for asset tracking management of the plurality of portable radio assets. The communication system 100 may further comprise workstation 110 having the graphical user interface 235, the workstation being in communication with the server 200 for accessing the database(s) to retrieve and display the dormant portable radio asset and dormant status subcategory associated therewith. The workstation 110 may further display the analytics pertaining to the dormant portable radio asset and dormant status subcategory associated therewith.

FIG. 3 illustrates an example method 300 for categorizing portable radio assets implemented by the system 100. As an example, the method 300 is explained in terms of the server 200 and the electronic processor 205. However, portions of the method 300 may be distributed among multiple devices/components (for example, across multiple processors of the system 100). For purposes of description, the method 300 is explained below in terms of the server 200, the portable radio asset 106, and the database 102. It should also be understood that the order of the steps performed may vary from the example provided.

In the example illustrated, at block 305, the processor 205 evaluates status data for the portable radio asset 106 obtained from the memory 210. The status data includes information or data indicating when a communication associated with the portable radio asset 106 was last received by the server 200. The communication may be from the portable radio asset 106 itself or, in embodiments where the portable radio asset 106 is a battery, from the device that the portable radio asset 106 is connected to. At block 310, the processor 205 determines that the portable radio asset 106 is dormant when a time period following receipt of the communication exceeds a predetermined threshold. The predetermined time period threshold may be a number of days (for example, a week, a month, and the like). The threshold is automatically generated, user-defined (for example, via the interface 235), or preset. In some embodiments, the threshold is a custom threshold for a particular portable radio asset.

At block 315, the processor 205 retrieves information corresponding to a situational circumstance of the portable radio asset 106 and, at block 320, performs analytics on the information. The information that is retrieved and analyzed by the processor 205 includes the information described above in reference to FIG. 1. In particular, the information collected is that which may be relevant to indicating the reason or situation in which why the portable radio asset 106 has been dormant and, thus, better characterize the dormant status for the particular portable radio asset. For example, the information may include information regarding a user assigned to the portable radio asset 106, a record of the portable radio asset 106 from an asset device supplier, an aging characteristic of the portable radio asset 106, a performance characteristic of the portable radio asset 106, and a last known location of the portable radio asset 106. The information regarding a user assigned to the portable radio asset 106 may include, for example, whether a user is currently on leave or vacation temporarily or has another portable radio asset assigned to them in addition to the portable radio asset 106. The record of the portable radio asset 106 from an asset device supplier may include whether the portable radio asset 106 was ever shipped or received at the enterprise utilizing the system 100. The aging characteristic of the portable radio asset 106 is time-related deterioration information of one or more electrical characteristics of the portable radio asset 106. The performance characteristic of a battery asset is time-related information regarding any malfunction or failure history of the battery asset. The last known location of a battery asset associated with the portable radio asset 106 may be indicated by GPS, RFID, or any other suitable location technology.

At block 325, the processor 205 categorizes, based on the analytics, the portable radio asset 106 into a subcategory. The subcategory, as mentioned above, further characterizes a dormant status of the portable radio asset 106 as to why the portable radio asset 106 has not communicated with the server 200 for more than the predetermined time threshold of block 310. The subcategory may be selected from a plurality of predetermined sub-categories. The predetermined plurality of sub-categories may include at least one selected from the group consisting of lost asset; damaged asset, asset currently-in-storage, asset not yet used, asset retired, and asset assigned to user on leave.

For example, information regarding a user assigned to the portable radio asset 106 may be evaluated to determine if the battery is dormant due to a situation of the user assigned to the portable radio asset 106. For example, the processor 205 may determine, based on a personal or enterprise calendar of the assigned user, whether the assigned user is currently on vacation or on temporary leave, hence the user may not be utilizing the device for the time.

Following the categorization at block 325, the processor 205 updates the database 102 to the dormant portable radio asset categorized in the dormant status subcategory (block 330). At block 335, the updated database is accessed by an external device for generation of a graphical user interface. The updated database, including the dormant portable radio asset categorized in the dormant status subcategory, is accessible to an external device communicating with the server through the cloud-based communication system for display on a graphical user interface of the external device (for example, the graphical user interface 235 of workstation 110 of FIG. 2B). FIGS. 5A-5B, described below in more detail, are exemplary screens 500A and 500B of the generated graphical user interface 235.

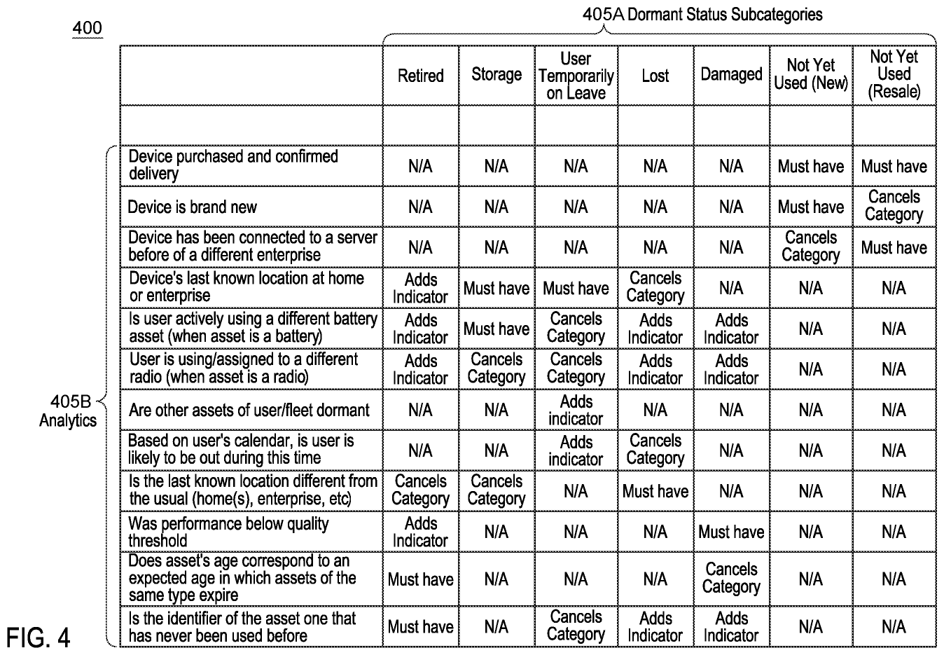

FIG. 4 illustrates a table 400 illustrating an example of analytics performed on the information retrieved in the determination of which subcategory the portable radio asset 106 should be categorized into. The table 400 includes a plurality of subcategories 405A and a plurality of analytical inquiries 405B evaluated by the processor 205. In the illustrated example (as well as the illustrated examples in FIGS. 5A-5B), the portable radio asset 106 being categorized is either a memory-enabled battery or an electronic radio. For each inquiry 405B, the result of the inquiry aids in the determination of a potential subcategory 405A depending on the inquiry and as processed preferably via machine learning.

The analytics may be based on inquiries that include, but are not limited to: user assignment to the portable radio asset, a record of the portable radio asset from an asset supplier database, asset usage since purchase from an asset supplier, an aging characteristic of the portable radio asset, a health status of the portable radio asset, a performance characteristic of the portable radio asset, and a last known location of the portable radio asset. The dormant status subcategory may then be assigned from a plurality of predetermined sub-categories, the predetermined plurality of sub-categories including at least one from the group consisting of: lost asset, damaged asset, asset currently-in-storage, asset not yet used, asset retired; and asset assigned to user on leave.

For example, for the dormant portable radio asset 106 may be categorized as “retired,” based on information indicating that the last determined location of the portable radio asset 106 is at a home of the user's or at the enterprise of the system 100 (for example, when the asset 106 is a battery), the user assigned to the portable radio asset 106 is using or is assigned a different portable radio asset (for example, when the asset 106 is an electronic device such as a radio), and that a performance of the portable radio asset 106 is determined to be less than a predetermined quality threshold all indicate a likelihood that the portable radio asset 106 is retired. Information indicating that the dormant portable radio asset 106 has not been seen for a certain number of days, that the portable radio asset 106 is close to or exceeds an expected expiration age (an age in which the device permanently fails or is normally retired), and that an identifier of a different portable radio asset that is currently being used by the user one that has not previously been used before are definite indications that the portable radio asset 106 has been retired whereas an indication that the last known location of the portable radio asset 106 is different from a usual/predetermined location cancels a possibility that the portable radio asset 106 may be categorized under the “retired” category.

As also illustrated in FIG. 4, in some embodiments, the electronic processor 205 is configured to categorize the dormant portable radio asset 106 into the dormant status subcategory based on asset usage of the portable radio asset 106 since being purchased from an asset supplier. When a portable radio asset 106 has not been used, it may be categorized as simply being new and not yet used (in stock and ready to be used). In some embodiments, the electronic processor is configured to categorize the portable radio asset 106 under the dormant status subcategory of a new electronic asset device category based on a purchase history of the portable radio asset 106. For example, the dormant status subcategory includes whether a not yet used portable radio asset 106 is brand new or is a resale (previously used by another enterprise) asset.

In some embodiments, the processor 205 is configured to utilize a predication algorithm to categorize the portable radio asset 106 based on previously stored classifications. The processor 205 may also utilize a machine learning algorithm to determine information for categorizing the portable radio asset 106. For example, in some embodiments, the processor 205 is configured to determine a health status of the dormant portable radio asset 106 based on analytics using a machine learning algorithm and categorize the portable radio asset 106 based on the determined health status. The processor 205 may thus predict the likelihood that the dormant portable radio asset 106 is damaged. As another example, the processor 205 may be configured to determine an expected age in which portable radio assets are retired by the enterprise based on previously retired portable radio assets and compare the age of the portable radio asset 106 to the expected age result. Similarly, in some embodiments, the electronic processor 205 is configured to categorize the portable radio asset 106 into a subcategory of a damaged electronic asset category based on a performance history of the portable radio asset 106.

FIGS. 5A and 5B each are exemplary screens 500A and 500B of the generated graphical user interface 235. As illustrated in FIG. 5A, the screen 500A includes an indication of the number of portable radio assets (in the illustrated example, radios) determined to be dormant (icon 502A). The screen 500A also includes a (partial) list of entries 504A corresponding to a plurality of portable radio assets (here, each under a particular public safety fleet). Screen 500B of FIG. 5B includes a list 504B of the portable radio assets categorized under the dormant category. As shown in both FIGS. 5A and 5B, information regarding the performance and usage of each of the battery asserts may also be displayed via the graphical user interface 235.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A server for tracking a portable radio asset in a cloud-based communication system, the server comprising:
an electronic processor communicatively coupled to a memory, the server communicating with a portable radio asset over a wireless connection of the cloud-based communication system, the electronic processor of the server configured to:
detect communications from the portable radio asset to the server;
evaluate status data, from the memory, for the portable radio asset, the status data including when a communication associated with the portable radio asset was last received by the server;
determine, by the server, that the portable radio asset is a dormant portable radio asset based on a time period without any communication from the portable radio asset to the server exceeding a predetermined time threshold;
retrieve information, from the server, corresponding to situational circumstances pertaining to user data of the dormant portable radio asset and the dormant portable radio asset itself;
perform analytics on the retrieved information pertaining to the dormant portable radio asset, the analytics including use based inquiries and device based inquiries to determine changes in the situational circumstances, the changes in the situational circumstances providing a basis for the portable radio asset going dormant;
categorize the dormant portable radio asset into a dormant status subcategory indicating the basis for the portable radio asset going dormant; and
display on a graphical user interface of an external device, in communication with the server, the dormant portable radio asset and basis for the asset going dormant.

2. The server of claim 1, wherein the electronic processor is configured to categorize the dormant portable radio asset into the dormant status subcategory based on analytics which determine at least one selected from the group consisting of:
user assignment to the portable radio asset;
a record of the portable radio asset from an asset supplier database;
asset usage since purchase from an asset supplier;
an aging characteristic of the portable radio asset;
a health status of the portable radio asset;
a performance characteristic of the portable radio asset; and
a last known location of the portable radio asset.

3. The server of claim 1, wherein the electronic processor is further configured to determine the dormant status subcategory from a plurality of predetermined sub-categories, the predetermined plurality of sub-categories including at least one from the group consisting of:
lost asset;
damaged asset;
asset currently-in-storage;
asset not yet used;
asset retired; and
asset assigned to user on leave.

4. The server of claim 3, wherein the analytics utilize a machine learning algorithm.

5. The server of claim 1, wherein the dormant portable radio asset is a dormant battery asset of a portable radio, and the electronic processor of the server is further configured to determine a health status of the dormant battery asset based on the analytics using a machine learning algorithm and to categorize the dormant battery asset based on the health status.

6. The server of claim 1, wherein the external device communicating with the server and database through the cloud-based communication system comprises a workstation, the workstation displaying the graphical user interface based on the dormant portable radio asset categorized in the dormant status subcategory.

7. A method of tracking a portable radio asset by a server in a cloud-based communication system, the method comprising:
receiving a communication from the portable radio asset;
evaluating status data for the portable radio asset from a memory, the status data including when a the communication associated with the portable radio asset was last received by the server;
storing the status data;
determining, by the server, that the portable radio asset is a dormant portable radio asset based on a time period without any communication from the portable radio asset to the server exceeding a predetermined time threshold;
retrieving information corresponding to a-situational circumstances of the dormant portable radio asset, the situational circumstances including previously stored user data and device data received during the communications;
performing analytics on the information pertaining to the dormant portable radio asset, the analytics including user based inquiries and device based inquiries to determine changes in the situational circumstances, the changes in the situational circumstances providing a basis for the portable radio asset going dormant,
categorizing, based on the analytics, the dormant portable radio asset into a dormant status subcategory indicating the basis for the portable radio asset going dormant; and
displaying on a graphical user interface of an external device, in communication with the server, the dormant portable radio asset and basis for the asset going dormant.

8. The method of claim 7, wherein the dormant portable radio asset is categorized into the dormant status subcategory based on at least one selected from the group consisting of:
user assignment to the portable radio asset;
a record of the portable radio asset from an asset supplier database;
asset usage since purchase of the portable radio asset from an asset supplier;
an aging characteristic of the portable radio asset;
a health status of the portable radio asset;
a performance characteristic of the portable radio asset; and
a last known location of the portable radio asset.

9. The method of claim 8, wherein the dormant status subcategory for the portable radio asset is selected from a plurality of predetermined sub-categories, the predetermined plurality of sub-categories including at least one selected from the group consisting of:
lost asset;
damaged asset;
asset currently-in-storage;
asset not yet used;
asset retired; and
asset assigned to user on leave.

10. The method of claim 9, wherein the analytics utilize a machine learning algorithm.

11. The method of claim 7, wherein the dormant portable radio asset is a dormant battery asset of a portable radio, and performing analytics on the information includes determining a health status of the dormant battery asset based on analytics using a machine learning algorithm and categorize the dormant battery asset based on the determined health status.

12. A communication system, comprising:
a plurality of portable radio assets;
a server receiving status data from each of the plurality of portable radio assets, the server determining when a portable radio asset of the plurality of portable radio assets has gone dormant based on a predetermined time threshold without any communication to the server, the server performing analytics on a dormant portable radio asset, the analytics including user and asset based inquiries to categorize the dormant portable radio asset into a dormant status subcategory and provide a basis for the portable radio asset going dormant;
a database for storing analytical results pertaining to the dormant portable radio asset including the dormant status subcategory and basis for the asset going dormant; and
the analytical results pertaining to the dormant portable radio asset including the dormant status subcategory and basis for going dormant being provided to a display of workstation for asset tracking management for the plurality of portable radio assets.

13. (canceled)

14. The communication system of claim 12 wherein the workstation further displays the analytics pertaining to the dormant portable radio asset and dormant status subcategory associated therewith.
